(19) United States
(12) Patent Application Publication
(10) Pub. No.: US 2025/0293912 A1
(43) Pub. Date: Sep. 18, 2025

(54) CYCLIC PREFIX FOR FORWARD LINK WAVEFORM

(71) Applicant: QUALCOMM Incorporated, San Diego, CA (US)

(72) Inventors: Raviteja PATCHAVA, San Diego, CA (US); Piyush GUPTA, Bridgewater, NJ (US); Zhifei FAN, San Diego, CA (US); Xiaoxia ZHANG, San Diego, CA (US)

(21) Appl. No.: 18/605,536

(22) Filed: Mar. 14, 2024

(51) Int. Cl. H04L 27/26; H04L 27/10; H04W 56/00

(52) U.S. Cl. CPC H04L 27/2605; H04L 27/10; H04W 56/0015

(57) ABSTRACT

Various aspects of the present disclosure generally relate to wireless communication. Some aspects more specifically relate to enabling an indication, transmitted from a wireless communication device to an ambient internet of things (IoT) device, that a cyclic prefix (CP) is to be included in the forward link waveform. In some aspects, the ambient IoT device may receive the forward link waveform and decode the forward link waveform in accordance with the indication that the CP is to be included in the forward link waveform. For example, the ambient IoT device may skip sampling of the forward link waveform during the CP.

### FIELD OF THE DISCLOSURE

Aspects of the present disclosure generally relate to wireless communication and specifically relate to techniques, apparatuses, and methods associated with a cyclic prefix for a forward link waveform.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

Ambient IoT devices may be unable to identify whether waveforms transmitted on a forward link have embedded cyclic prefixes (CPs). As a result, without information relating to the CPs, the ambient IoT devices may be unable to support the waveforms with embedded CPs. For example, ambient IoT devices may decode waveforms with CPs differently than waveforms without CPs. Because CPs support multiplexing, and because ambient IoT devices without the information relating to the CPs do not support waveforms with CPs, ambient IoT devices without information relating to the CPs may be unable to support multiplexing of waveforms.

### SUMMARY

Some aspects described herein relate to an apparatus for wireless communication at an ambient internet of things (IoT) device. The apparatus may include one or more memories storing processor-executable code and one or more processors coupled with the one or more memories. At least one processor of the one or more processors may be configured to cause the ambient IoT device to receive an indication that a cyclic prefix (CP) is to be included in a forward link waveform. At least one processor of the one or more processors may be configured to cause the ambient IoT device to decode the forward link waveform in accordance with the indication that the CP is to be included in the forward link waveform.

Some aspects described herein relate to an apparatus for wireless communication at a wireless communication device. The apparatus may include one or more memories storing processor-executable code and one or more processors coupled with the one or more memories. At least one processor of the one or more processors may be configured to cause the wireless communication device to transmit an indication that a CP is to be included in a forward link waveform associated with an ambient IoT device. At least one processor of the one or more processors may be configured to cause the wireless communication device to transmit the forward link waveform in accordance with the indication that the CP is to be included in the forward link waveform.

Some aspects described herein relate to a method of wireless communication performed at an ambient IoT device. The method may include receiving an indication that a CP is to be included in a forward link waveform. The method may include decoding the forward link waveform in accordance with the indication that the CP is to be included in the forward link waveform.

Some aspects described herein relate to a method of wireless communication performed at a wireless communication device. The method may include transmitting an indication that a CP is to be included in a forward link waveform associated with an ambient IoT device. The method may include transmitting the forward link waveform in accordance with the indication that the CP is to be included in the forward link waveform.

Some aspects described herein relate to a non-transitory computer-readable medium that stores a set of instructions for wireless communication. The set of instructions may include one or more instructions that, when executed at an ambient IoT device, cause the ambient IoT device to receive an indication that a CP is to be included in a forward link waveform. The set of instructions may include one or more instructions that, when executed at an ambient IoT device, cause the ambient IoT device to decode the forward link waveform in accordance with the indication that the CP is to be included in the forward link waveform.

Some aspects described herein relate to a non-transitory computer-readable medium that stores a set of instructions for wireless communication. The set of instructions may include one or more instructions that, when executed at a wireless communication device, cause the wireless communication device to transmit an indication that a CP is to be included in a forward link waveform associated with an ambient IoT device. The set of instructions may include one or more instructions that, when executed at a wireless communication device, cause the wireless communication device to transmit the forward link waveform in accordance with the indication that the CP is to be included in the forward link waveform.

Some aspects described herein relate to an apparatus for wireless communication. The apparatus may include means for receiving an indication that a CP is to be included in a forward link waveform. The apparatus may include means for decoding the forward link waveform in accordance with the indication that the CP is to be included in the forward link waveform.

Some aspects described herein relate to an apparatus for wireless communication. The apparatus may include means for transmitting an indication that a CP is to be included in a forward link waveform associated with the ambient IoT device 135. The apparatus may include means for transmitting the forward link waveform in accordance with the indication that the CP is to be included in the forward link waveform.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network.

FIG. 2 is a diagram illustrating an example network node in communication with an example user equipment (UE) in a wireless network.

FIG. 3 is a diagram illustrating an example associated with backscatter communications.

FIG. 4 is a diagram illustrating an example associated with envelope tracking.

FIG. 5 is a diagram illustrating an examples associated with on-off keying (OOK) waveforms.

FIG. 6 is a diagram illustrating an example associated with enabling cyclic prefixes for forward link waveforms.

FIG. 7 is a diagram illustrating an example associated with an OOK waveform transmitted with a cyclic prefix (CP).

FIG. 8 is a flowchart illustrating an example process performed, for example, at an ambient internet of things (IoT) device or an apparatus of an ambient IoT device that supports a CP for forward link waveforms.

FIG. 9 is a flowchart illustrating an example process performed, for example, at a wireless communication device or an apparatus of a wireless communication device that supports a CP for forward link waveforms.

FIG. 10 is a diagram of an example apparatus for wireless communication, such as an ambient IoT device, that supports CPs for forward link waveforms.

FIG. 11 is a diagram of an example apparatus for wireless communication, such as a wireless communication device, that supports CPs for forward link waveforms.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Some wireless communication devices may be ambient internet of things (IoT) devices, which may comprise a terminal, such as a radio frequency identification (RFID) device, a tag, or a similar device. Ambient IoT devices may be a type A device, type B device, or type C device: type A ambient IoT devices may have no energy storage (for example, battery) or independent signal generation; type B ambient IoT devices may have energy storage but no independent signal generation; and type C ambient IoT devices may have energy storage and independent signal generation. In some examples, ambient IoT devices may accumulate energy from radio signaling and/or communicate data by backscattering radio signaling. In some examples, a wireless communication device (for example, a network node or a user equipment (UE)) may transmit waveforms (for example, radio signaling) to an ambient IoT device over a forward link.

Ambient IoT devices may be unable to identify whether forward link waveforms have embedded cyclic prefixes (CPs). As a result, the ambient IoT devices may be unable to decode the forward link waveforms with embedded CPs. For example, ambient IoT devices may decode the forward link waveforms with CPs differently than forward link waveforms without CPs. Because CPs support multiplexing and ambient IoT devices do not support forward link waveforms with CPs, ambient IoT devices may be unable to support multiplexing of forward link waveforms. Without multiplexing, the forward link waveforms may use excessive resources for transmission.

Various aspects relate generally to enabling CPs for forward link waveforms. Some aspects more specifically relate to enabling an indication, transmitted from a wireless communication device to an ambient IoT device, that a CP is to be included in the forward link waveform. In some aspects, the ambient IoT device may receive the forward link waveform and decode the forward link waveform in accordance with the indication that the CP is to be included in the forward link waveform. For example, the ambient IoT device may skip sampling of the forward link waveform during the CP.

In some aspects, the indication that the CP is to be included in the forward link waveform may comprise a system information block (SIB) or a synchronization signal. In examples where the indication that the CP is to be included in the forward link waveform comprises the SIB, the SIB may be transmitted without any CP. The wireless communication device may also transmit a synchronization signal that may or may not be transmitted with a CP. In examples where the indication that the CP is to be included in the forward link waveform comprises the synchronization signal, the synchronization signal may be different than a synchronization signal that the wireless communication device would use to indicate that a CP is not to be included in a forward link waveform. For example, the wireless communication device may select different synchronization signals (for example, different sequences of bits) depending on whether or not the CP is to be included in the forward link waveform.

In some aspects, the wireless communication device may transmit, to the ambient IoT device, an indication of a duration of the CP. The indication of the duration of the CP may be explicit or implicit. For example, an explicit indication of the duration of the CP may be one or more bits indicating the duration of the CP. Additionally or alternatively, the indication of the duration of the CP may be implicit using a subcarrier spacing (SCS). For example, the SCS of a transmission from the wireless communication device to the ambient IoT device may correspond to the duration of the CP.

Particular aspects of the subject matter described in this disclosure can be implemented to realize one or more of the following potential advantages. In some examples, by transmitting and/or decoding the forward link waveform in accordance with the indication that the CP is to be included in the forward link waveform, the described techniques can be used to support multiplexing of forward link waveforms. For example, the indication may enable the ambient IoT device to properly decode forward link waveforms containing CPs. As a result, the wireless communication device may multiplex transmissions with the forward link waveform and thereby conserve transmission resources.

The indication of the duration of the CP may enable the ambient IoT device to properly decode the forward link waveform. For example, the duration of the CP may enable the ambient IoT device to identify CP symbol boundaries (for example, the ambient IoT device may identify the symbols at which the CP starts and ends). As a result, the ambient IoT device may accurately skip the CP samples during the CP.

The indication that the CP is to be included in the forward link waveform comprising the SIB may enable the ambient IoT device to perform a relatively low-complex search for the SIB (for example, rather than performing a relatively high-complexity search for different synchronization signals). Additionally or alternatively, the indication that the CP is to be included in the forward link waveform comprising the synchronization signal may enable the SIB to be transmitted with a CP, and, thus, the SIB may be multiplexed using frequency division multiplexing (FDM), which may further conserve transmission resources.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, IoT connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

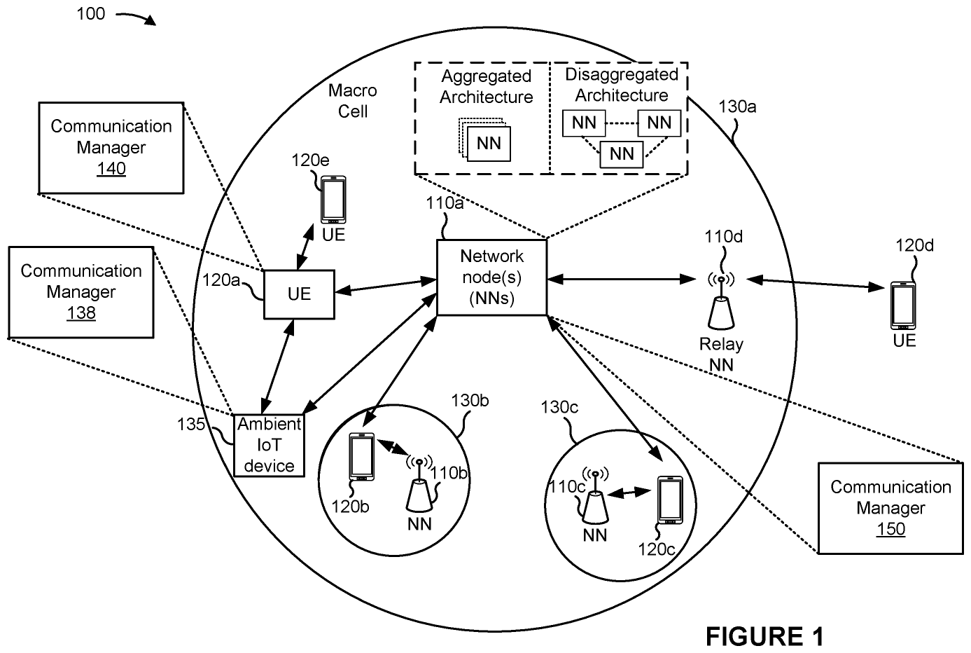

FIG. 1 is a diagram illustrating an example of a wireless communication network 100. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120c.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHZ), FR2 (24.25 GHz through 52.6 GHZ), FR3 (7.125 GHz through 24.25 GHZ), FR4a or FR4-1 (52.6 GHz through 71 GHZ), FR4 (52.6 GHZ through 114.25 GHZ), and FR5 (114.25 GHz through 300 GHz). Although a portion of FR1 is greater than 6 GHZ, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHZ,” if used herein, may broadly refer to frequencies that are less than 6 GHZ, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/Long-Term Evolution (LTE) and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node.

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, Institute of Electrical and Electronics Engineers (IEEE) compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

In some examples, two or more UEs 120 (for example, shown as UE 120a and UE 120c) may communicate directly with one another using sidelink communications (for example, without communicating by way of a network node 110 as an intermediary). As an example, the UE 120a may directly transmit data, control information, or other signaling as a sidelink communication to the UE 120c. This is in contrast to, for example, the UE 120a first transmitting data in an UL communication to a network node 110, which then transmits the data to the UE 120e in a DL communication.

In some aspects, an ambient IoT device 135 may be configured for communication with the network node 110 and/or the UE 120. In some examples, the ambient IoT device 135 may be a type A device, type B device, or type C device. In some examples, the ambient IoT device 135 may be configured to accumulate energy from radio signaling received from the network node 110 and/or the UE 120. In some examples, the ambient IoT device 135 may be configured to communicate data to the network node 110 and/or the UE 120 by backscattering radio signaling received from the network node 110 and/or the UE 120. The ambient IoT device 135 is further described elsewhere herein.

In some aspects, the ambient IoT device 135 may include a communication manager 138. As described in more detail elsewhere herein, the communication manager 138 may receive an indication that a CP is to be included in a forward link waveform; and decode the forward link waveform in accordance with the indication that the CP is to be included in the forward link waveform. Additionally or alternatively, the communication manager 138 may perform one or more other operations described herein.

In some aspects, a wireless communication device (for example, the network node 110 or the UE 120, among other examples) may include a communication manager 140 or 150. As described in more detail elsewhere herein, the communication manager 140 or 150 may transmit an indication that a CP is to be included in a forward link waveform associated with the ambient IoT device; and transmit the forward link waveform in accordance with the indication that the CP is to be included in the forward link waveform. Additionally or alternatively, the communication manager 140 or 150 may perform one or more other operations described herein.

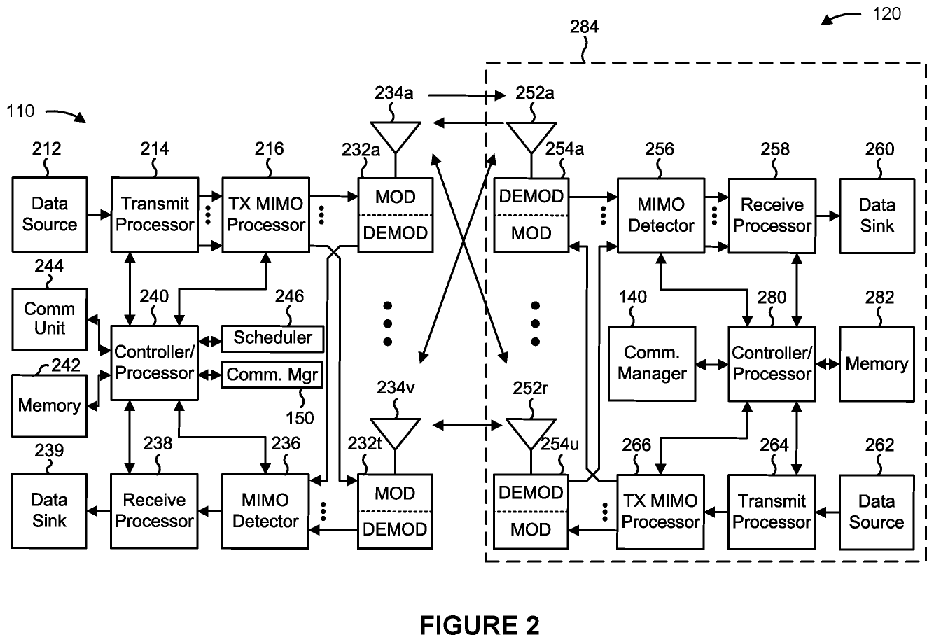

FIG. 2 is a diagram illustrating an example network node 110 in communication with an example UE 120 in a wireless network.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor” or “a/the controller/processor,” (in the singular), among other examples, should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use downlink control information (DCI) to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may identify, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a uplink control information (UCI) communication, a MAC control element (MAC-CE) communication, an RRC communication, or another type of uplink communication. Uplink signals may be transmitted on a physical uplink shared channel (PUSCH), a physical uplink control channel (PUCCH), and/or another type of uplink channel. An uplink signal may carry one or more transport blocks (TBs) of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range. The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal.

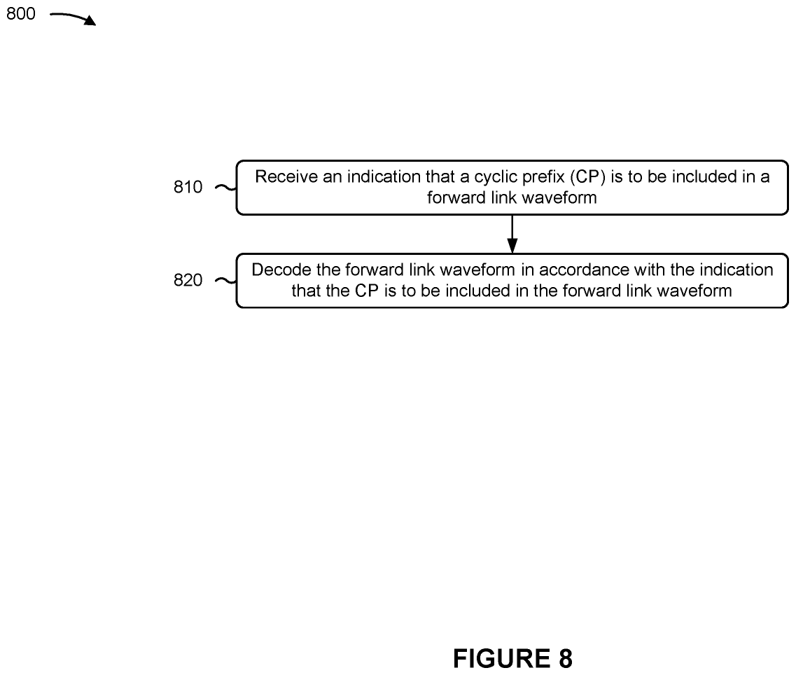

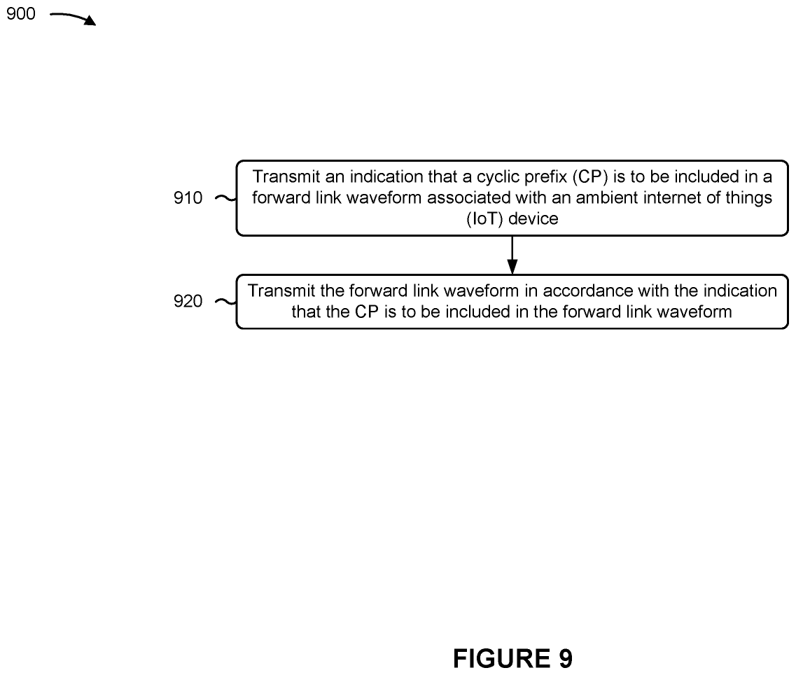

The network node 110, the controller/processor 240 of the network node 110, the UE 120, the controller/processor 280 of the UE 120, a CU, a DU, an RU, or any other component(s) of FIG. 1 or 2 may implement one or more techniques or perform one or more operations associated with CP for forward link waveforms, as described in more detail elsewhere herein. For example, the controller/processor 240 of the network node 110, the controller/processor 280 of the UE 120, any other component(s) of FIG. 2, the CU, the DU, or the RU may perform or direct operations of, for example, process 800 of FIG. 8, process 900 of FIG. 9, or other processes as described herein (alone or in conjunction with one or more other processors). The memory 242 may store data and program codes for the network node 110, the network node 110, the CU, the DU, or the RU. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU, the DU, or the RU, may cause the one or more processors to perform process 800 of FIG. 8, process 900 of FIG. 9, or other processes as described herein. In some examples, executing instructions may include running the instructions, converting the instructions, compiling the instructions, and/or interpreting the instructions, among other examples. In some aspects, the ambient IoT device 135 described herein is the UE 120, is included in the UE 120, or includes one or more components of the UE 120 shown in FIG. 2. In some aspects, the wireless communication device described herein is the network node 110 or the UE 120, is included in the network node 110 or the UE 120, or includes one or more components of the network node 110 or the UE 120 shown in FIG. 2.

In some aspects, the ambient IoT device 135 includes means for receiving an indication that a CP is to be included in a forward link waveform; and/or means for decoding the forward link waveform in accordance with the indication that the CP is to be included in the forward link waveform. In some aspects, the means for the ambient IoT device 135 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the wireless communication device includes means for transmitting an indication that a CP is to be included in a forward link waveform associated with the ambient IoT device 135; and/or means for transmitting the forward link waveform in accordance with the indication that the CP is to be included in the forward link waveform. In some aspects, the means for the wireless communication device to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246. In some aspects, the means for the wireless communication device to perform operations described herein may include, for example, one or more of communication manager 140, antenna 252, modem 254, MIMO detector 256, receive processor 258, transmit processor 264, TX MIMO processor 266, controller/processor 280, or memory 282.

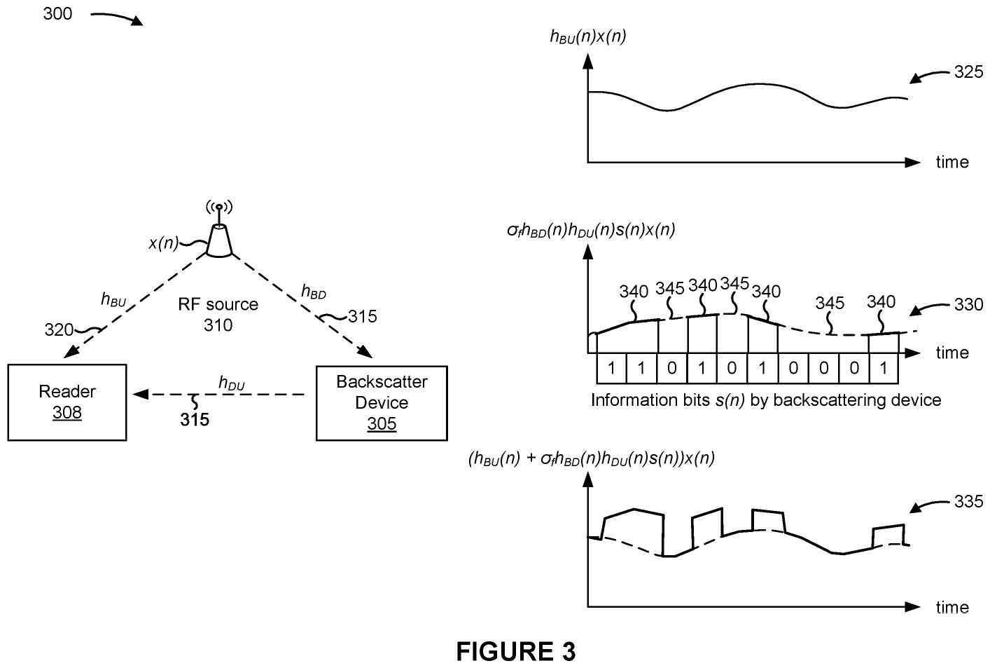

FIG. 3 is a diagram illustrating an example 300 associated with backscatter communications.

Some wireless communication devices may be considered IoT devices, such as ambient IoT devices (sometimes referred to as ultra-light IoT devices), or similar IoT devices. In ambient IoT, a terminal (for example, an RFID device, a tag, or a similar device) may not include a battery, and the terminal may accumulate energy from radio signaling. To achieve further cost reduction and zero-power communication, wireless networks may utilize a type of ambient IoT device referred to as an “ambient backscatter device” or a “backscatter device.”

As shown in FIG. 3, a backscatter device 305 (for example, a tag or a sensor, among other examples), which may be one example of an ambient IoT device, may employ a simplified hardware design (for example, including a power splitter, an energy harvester, and a microcontroller) that does not include a battery, such that the backscatter device 305 relies on energy harvesting for power, and that does not include a radio wave generation circuit, such that the backscatter device 305 is capable of transmitting information only by reflecting a radio wave. More particularly, the backscatter device 305 communicates with a reader 308 (for example, a UE 120, a network node 110, or another network device) by modulating a reflecting radio signal from an RF source 310 (for example, a network node 110, a UE 120, or another network device). In some examples, the RF source 310 and the reader 308 may be the same device and/or may be co-located. For example, in some instances, the reader 308 and the RF source 310 may be associated with the same network node 110.

To facilitate communication of the backscatter device 305, the RF source 310 may transmit an energy harvesting wave to the backscatter device 305. The energy harvesting wave may be transmitted for a sufficient duration in order to enable a communication phase for a target range between the reader 308 and the backscatter device 305. Additionally or alternatively, in some instances, a range between the RF source 310 and the backscatter device 305 may be limited by a minimum received power for triggering energy harvesting at the backscatter device 305, such as −20 decibel milliwatts (dBm).

Once energy is sufficiently accumulated at the backscatter device 305, the backscatter device 305 may begin to reflect the radio wave that is radiated onto the backscatter device 305 via a backscatter link 315. For example, the RF source 310 may initiate a communication session (sometimes referred to as a query-response communication) with a query, which may be a modulating envelope of a continuous wave (CW). The backscatter device 305 may respond by backscattering of the CW. The communication session may include multiple rounds, such as for purposes of contention resolution when multiple backscatter devices respond to a query. A channel between the RF source 310 and the backscatter device 305 of the backscatter link 315 may be associated with a first backscatter link channel response value (sometimes referred to as a first backscatter link channel coefficient or a first backscatter link gain value), hBD. As described below, the backscatter device 305 may have reflection-on periods and reflection-off periods that follow a pattern that is based at least in part on the transmission of information bits by the backscatter device 305. The reader 308 may detect the reflection pattern of the backscatter device 305 and obtain the backscatter communication information via the backscatter link 315. A channel between the reader 308 and the backscatter device 305 of the backscatter link 315 may be associated with a second backscatter link channel response value (sometimes referred to as a second backscatter link channel coefficient or a second backscatter link channel gain value), hDU. In addition, the RF source 310 and the reader 308 may communicate (for example, reference signals and/or data signals) via a direct link 320. A channel between the RF source 310 and the reader 308 of the direct link 320 may be associated with a direct link channel response value (sometimes referred to as a direct link channel coefficient or a direct link channel gain value), hBU.

The backscatter device 305 may use an information modulation scheme, such as amplitude shift keying (ASK) modulation or OOK modulation. For ASK or OOK modulation, the backscatter device 305 may switch on reflection when transmitting an information bit “1” and switch off reflection when transmitting an information bit “0.” In backscatter communication, the RF source 310 may transmit a particular radio wave (for example, a reference signal or a data signal, such as a physical downlink shared channel (PDSCH)), which may be denoted as x(n). The reader 308 may receive this radio wave, x(n), directly from the RF source 310 via the direct link 320, as well as from the backscatter device 305 modulating and reflecting the radio wave to the reader 308 via the backscatter link 315. The signal received at the reader 308 via the direct link 320, indicated by reference number 325, is the product of the radio wave transmitted by the RF source 310, x(n), multiplied by the direct link channel response value, hBU, plus any signal noise. The information bits signal of the backscatter device 305 may be denoted as s(n) where s(n)∈{0,1}. Accordingly, the signal received at the reader 308 via the backscatter link 315, indicated by reference number 330, is the product of the signal transmitted by the RF source 310, x(n), multiplied by the first backscatter link channel response value, hBD, the second backscatter link channel response value, hDU, the information bits signal from the backscatter device 305, s(n), and a reflection coefficient associated with the backscatter device 305 plus any noise.

Thus, the resulting signal received at the reader 308, which is the superposition of the signal received via the direct link 320 and the signal received via the backscatter link 315, may be denoted asy(n). This signal,y(n), is shown by reference number 335. As shown, when s(n)=0 (indicated by reference number 340 in the plot shown at reference number 330), the backscatter device 305 may switch off reflection, and thus the reader 308 receives only the direct link 320 signal. When s(n)=1 (indicated by reference number 345 in the plot shown at reference number 330), the backscatter device 305 may switch on reflection, and thus the reader 308 receives a superposition of both the direct link 320 signal and the backscatter link 315 signal. To receive the information bits transmitted by the backscatter device 305, the reader 308 may first decode x(n) based at least in part on the direct link channel response value of h_BU (n) by treating the backscatter link 315 signal as interference. The reader 308 may then detect the existence of the signal component. In some implementations provided herein, the backscatter device 305 (for example, ambient IoT device 135) may use envelope tracking to decode a waveform that contains a CP.

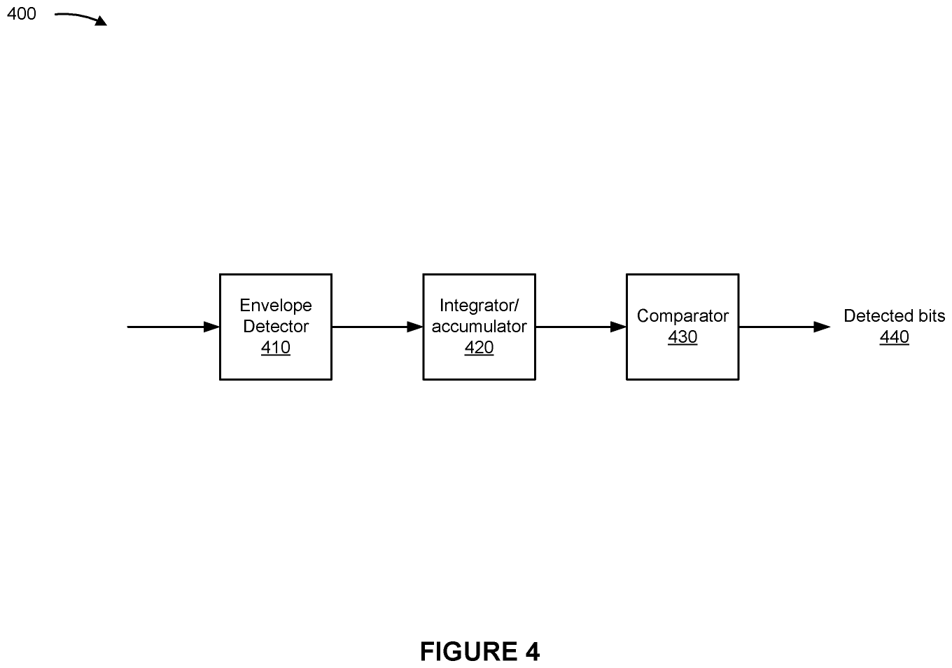

FIG. 4 is a diagram illustrating an example 400 associated with envelope tracking. The operations described and depicted in connection with FIG. 4 may be performed by an ambient IoT device (for example, a low-tier device). For example, the network entity may not include active RF components, such as a local oscillator, a power amplifier, a low noise amplifier, a mixer, and/or other RF components.

Envelope tracking may be used by the ambient IoT device to decode wireless signals. For example, envelope tracking can be used as a technique to detect and extract a modulated signal. Envelope tracking may be utilized by the ambient IoT device to detect a signal that is transmitted over a forward link. A “forward link” may be a wireless link configured to carry signals from a wireless communication device to an ambient IoT device.

Upon receiving a signal, an ambient IoT device may provide the signal (or information associated with the signal) to an envelope detector 410. The envelope detector 410 may be configured to detect an envelope of the signal. For example, the envelope detector 410 may detect energy associated with the envelope. In some examples, the envelope detector 410 may obtain multiple energy samples of the signal within a single symbol (for example, in cases where the sampling rate is greater than the symbol rate).

The ambient IoT device may provide the detected envelope (and/or information associated with the detected envelope) to an integrator or accumulator 420. The integrator or accumulator 420 may be configured to combine (for example, integrate or accumulate) the energy from multiple samples that were obtained within a single symbol. In cases where the sampling rate is not greater than the symbol rate, the ambient IoT device may skip the integrator or accumulator 420.

The ambient IoT device may provide the combined energy (and/or the detected envelope) to a comparator 430. The comparator 430 may be a component configured to identify whether the signal within a given symbol is to be associated with a “1” or a “0” (for example, for information bits of the signal). For example, the comparator 430 may compare the combined energy of the signal in a symbol to one or more energy thresholds. As an example, if a value of energy at a given time satisfies an energy threshold, then the comparator 430 may identify that the signal is associated with a “1” at the given time. If a value of energy at a given time does not satisfy the energy threshold, then the comparator 430 may identify that the signal is associated with a “0” at the given time.

The comparator 430 may output an indication of one or more detected bits 440 (for example, information bits) of the signal with values of “1” or a “0,” and the ambient IoT device may decode the information bits (for example, a series of “1” and/or “0” values) in accordance with the output of the comparator 430. As a result, a decoding operation performed by the ambient IoT device may be simplified and/or associated with reduced complexity. For example, the ambient IoT device may obtain values of the information bits of the signal without using one or more active RF components. Additionally, the network entity may obtain values of the information bits of the signal without down-converting the signal (for example, to a baseband signal). As another example, the envelope tracking decoding operation may enable the ambient IoT device to obtain values of the information bits of the signal without performing a carrier frequency offset and/or frequency synchronization. In some implementations provided herein, an ambient IoT device may use envelope tracking to decode a waveform that contains a CP.

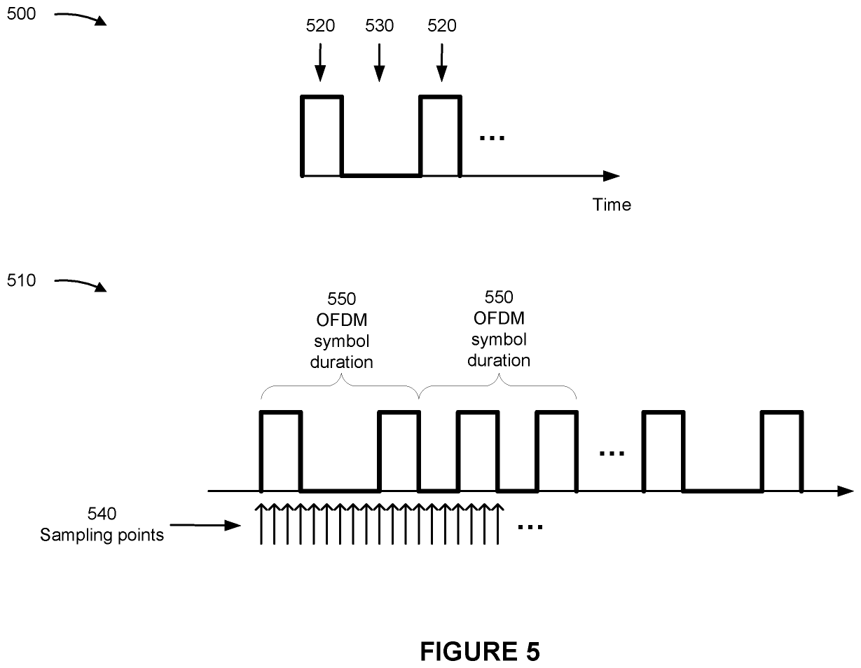

FIG. 5 is a diagram illustrating an examples 500 and 510 associated with OOK waveforms.

Example 500 illustrates an OOK waveform. OOK is a modulation scheme that conveys data by varying a power level of a carrier wave. For example, the presence of a carrier wave in a given time window may represent a bit value of “1,” and the absence of the carrier wave in a given time window may represent a bit value of “0.” The carrier wave may be present in time windows 520 and absent in time windows 530. In some examples, the OOK waveform may be used to convey a low-power wake-up signal (LP-WUS) over a forward link. OOK waveforms may be generated using OFDM waveforms and may be easily multiplexed with other UE data signals.

Example 510 illustrates an OOK waveform that can be decoded by an ambient IoT device operating in a standalone deployment (for example, the ambient IoT device may be in a standalone mode). In the standalone deployment, a wireless communication device (for example, a network node or a UE, among other examples) may exchange data transmissions (for example, user transmissions) with only the ambient IoT device. Because there are no other data transmissions, the OOK waveform need not be multiplexed with other data transmissions. Therefore, the wireless communication device may generate the OOK waveform using OFDM without appending a CP, which may be used for multiplexing.

Upon receiving the OOK waveform (for example, the OOK waveform without a CP), the ambient IoT device may sample the OOK waveform at sampling points 540. Because there is no CP, the OFDM symbol durations 550 are consecutive (for example, uninterrupted by a CP), and the ambient IoT device may sample the OOK waveform continuously.

In co-source deployments, other data transmissions (for example, associated with other ambient IoT devices) may be present. Embedding a CP in the OOK waveform may support multiplexing of the OOK waveform with the other data transmissions and, thus, conserve resources used to transmit the OOK waveform and/or other data transmissions. However, the ambient IoT device may be unable to decode the OOK waveform with an embedded CP because the ambient IoT device cannot identify whether the OOK waveform has a CP. For example, ambient IoT devices may decode the OOK waveforms with CPs differently than OOK waveforms without CPs. For example, due to the presence of the CPs, continuous sampling may be incompatible with OOK waveforms with CPs.

As a result, co-source deployments may be unable to support multiplexing of OOK waveforms. More generally, because the ambient IoT device cannot identify whether the OOK waveform has a CP, co-source deployments may be unable to support multiplexing of forward link waveforms, such as ASK waveforms (of which OOK waveforms may be one example), frequency shift keying (FSK) waveforms or phase shift keying (PSK) waveforms, among other examples. Some implementations described herein enable the ambient IoT device to distinguish between forward link waveforms with a CP and forward link waveforms without a CP.

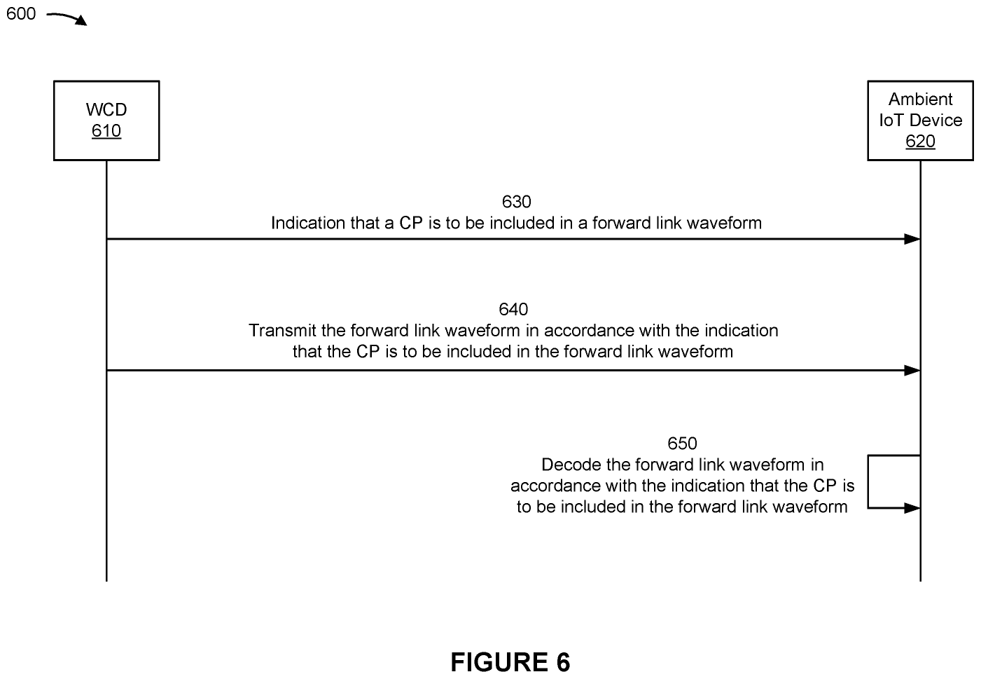

FIG. 6 is a diagram illustrating an example 600 associated with enabling cyclic prefixes for forward link waveforms. As shown in FIG. 6, a wireless communication device (“WCD”) 610 and an ambient IoT device 620 may communicate with one another. In some aspects, the wireless communication device 610 may be a UE (for example, UE 120) or a network node (for example, network node 110). In some aspects, the ambient IoT device 620 may be the ambient IoT device 135, such as a tag or a UE, among other examples.

In a first operation 630, the wireless communication device 610 may transmit, and the ambient IoT device 620 may receive, an indication that a CP is to be included in a forward link waveform. In some examples, the forward link waveform may be associated with the ambient IoT device 620. For example, the forward link waveform may be associated with the ambient IoT device 620 in that the forward link waveform may be transmitted over a forward link between the wireless communication device 610 and the ambient IoT device 620 (for example, the forward link waveform may be transmitted to the ambient IoT device 620). The indication that the CP is to be included in the forward link waveform may inform the ambient IoT device 620 regarding the inclusion of the CP in the forward link waveform (for example, the indication that the CP is to be included in the forward link waveform may inform the ambient IoT device 620 that the forward link waveform includes the CP).

In some aspects, the indication that the CP is to be included in the forward link waveform may comprise at least one of a SIB or a synchronization signal (for example, a time synchronization signal). For example, the wireless communication device 610 may inform the ambient IoT device 620 that that the CP is to be included in the forward link waveform using the SIB or the synchronization signal. Additionally or alternatively, the SIB or the synchronization signal may include details regarding the inclusion of the CP in the forward link waveform. For example, the details may include a duration of the CP, which is discussed further elsewhere herein. In some aspects, the ambient IoT device 620 may decode the SIB or the synchronization signal, which may enable the ambient IoT device 620 to identify whether the CP is to be included in the forward link waveform.

In some aspects, the indication that the CP is to be included in the forward link waveform may comprise the SIB. For example, after transmitting the synchronization signal, the wireless communication device 610 may transmit the SIB. In some examples, the synchronization signal and/or the SIB may be transmitted without any CP and in a duration associated with non-FDM data transmissions. The duration may be associated with non-FDM data transmissions in that the wireless communication device 610 may refrain from transmitting data using FDM during the duration in which the synchronization signal is transmitted. For example, the wireless communication device 610 may transmit the synchronization signal and/or the SIB without a CP (for example, the synchronization signal and/or the SIB may not include a CP), and, as a result, the wireless communication device 610 may not perform FDM of data symbols during the transmission of the synchronization signal and/or the SIB. In some examples, the synchronization signal may be transmitted with a CP, and the perform FDM of data symbols during the transmission of the synchronization signal.

In some aspects, the indication that the CP is to be included in the forward link waveform may comprise the synchronization signal. For example, the wireless communication device 610 may signal CP information (for example, the indication that the CP is to be included in the forward link waveform and/or details regarding the inclusion of the CP in the forward link waveform) using the synchronization signal. In some examples, the synchronization signal may be different than a synchronization signal that the wireless communication device 610 would use to indicate that a CP is not to be included in a forward link waveform. For example, the wireless communication device 610 may select different synchronization signals (for example, different sequences of bits) depending on whether or not the CP is to be included in the forward link waveform.

In some aspects (for example, where the indication that the CP is to be included in the forward link waveform comprises the synchronization signal), the synchronization signal may be transmitted without any CP and in a duration associated with non-FDM data transmissions. The duration may be associated with non-FDM data transmissions in that the wireless communication device 610 may refrain from transmitting data using FDM during the duration in which the synchronization signal is transmitted. For example, the wireless communication device 610 may transmit the synchronization signal without a CP (for example, the synchronization signal may not include a CP), and, as a result, the wireless communication device 610 may not perform FDM of data symbols during the transmission of the synchronization signal. In some examples, the synchronization signal may be transmitted with a CP, and the wireless communication device 610 may perform FDM of data symbols during the transmission of the synchronization signal.

In some aspects, the indication that the CP is to be included in the forward link waveform may comprise a control signal associated with the forward link waveform. The control signal may be associated with the forward link waveform in that the control signal may contain control information for the forward link waveform. For example, the wireless communication device 610 may transmit a communication (for example, a downlink communication) that includes control bits and/or data bits, where the control bits contain the CP information and the data bits comprise the forward link waveform.

In a second operation 640, the wireless communication device 610 may transmit the forward link waveform in accordance with the indication that the CP is to be included in the forward link waveform. The wireless communication device 610 may transmit the forward link waveform in accordance with the indication that the CP is to be included in the forward link waveform in that the wireless communication device 610 may include the CP in the forward link waveform (for example, the wireless communication device 610 may transmit the forward link waveform using the CP). In other examples, where the indication is that the CP is not to be included in the forward link waveform, the wireless communication device 610 may not include the CP in the forward link waveform (for example, the wireless communication device 610 may transmit the forward link waveform using no CPs).

In some aspects, the ambient IoT device 620 may receive the forward link waveform including the CP. For example, the ambient IoT device 620 may receive the indication comprising the SIB or the synchronization signal. In some examples (for example, where the ambient IoT device 620 receives the indication comprising the synchronization signal), the wireless communication device 610 may transmit the forward link waveform with the CP after transmitting the SIB, which may help to ensure backward compatibility with NR.

The forward link waveform may be any suitable type of forward link waveform. For example, the forward link waveform may be modulated using any suitable modulation scheme. In some aspects, the forward link waveform may be an OOK waveform. In some examples, the forward link waveform may be an ASK waveform (for example, an OOK waveform or another type of ASK waveform). In some examples, the forward link waveform may be an FSK waveform or a PSK waveform, among other examples.

In some aspects, the wireless communication device 610 may transmit, and the ambient IoT device 620 may receive, an indication of a duration of the CP. The duration of the CP may be a length of time (for example, a quantity of symbols) of the CP transmission. Thus, the wireless communication device 610 may inform the ambient IoT device 620 regarding CP duration. The indication of the duration of the CP may be explicit or implicit. For example, an explicit indication of the duration of the CP may be one or more bits indicating the duration of the CP. Additionally or alternatively, the indication of the duration of the CP may be implicit using an SCS (for example, the SCS of a transmission from the wireless communication device 610 to the ambient IoT device 620 may correspond to the duration of the CP). Thus, the wireless communication device 610 may signal, to the ambient IoT device 620, the indication of the duration of the CP.

In some aspects, one or more of the duration of the CP or a symbol duration of the forward link waveform is an integer multiple of a sampling rate (for example, a sampling clock rate) of the ambient IoT device. CP duration may be an integer multiple of the sampling rate for both long and short CPs. The symbol duration of the forward link waveform (for example, an OOK symbol duration) may be an OFDM symbol duration divided by a quantity of symbols (for example, OOK symbol) in one OFDM symbol. In some examples, the sampling clock rate of the ambient IoT device 620 may be restricted (for example, to within a few MHZ), which may enable low-cost and low-power implementation at the ambient IoT device 620. For example, in the case of a SCS of 15 kHz and 4 OOK symbols for OFDM, the sampling rate at the ambient IoT device 620 may satisfy these constraints if the sampling rate is a multiple of 1.92 MHZ. For a sampling rate of 1.92 MHZ, a short CP may correspond to 9 samples, a long CP may correspond to 10 samples, and each OOK symbol may correspond to 32 samples.

In a third operation 650, the ambient IoT device 620 may decode (for example, receive, detect, demodulate, and/or otherwise process) the forward link waveform in accordance with the indication that the CP is to be included in the forward link waveform. The ambient IoT device 620 may decode the forward link waveform in accordance with the indication that the CP is to be included in the forward link waveform in that the ambient IoT device 620 may decode the forward link waveform based at least in part on the CP being in the forward link waveform.

In some aspects (for example, where the ambient IoT device 620 decodes the SIB or the synchronization signal), the ambient IoT device 620 may decode the forward link waveform by skipping detection of the CP. For example, after decoding the SIB and/or the synchronization signal, the ambient IoT device 620 may identify that the ambient IoT device 620 is to skip one or more CP samples for purposes of detection. For example, if the duration of the CP is approximately 5 μs (for example, for a SCS of 15 kHz), and the ambient IoT device 620 operates at a sampling rate greater than 0.2 μs (200 kHz), then the ambient IoT device 620 may skip sampling in the duration of the CP (for example, the CP symbol duration) after envelop detection.

Transmitting and/or decoding the forward link waveform in accordance with the indication that the CP is to be included in the forward link waveform may help to support co-source deployments in addition to standalone deployments. For example, the indication may enable the ambient IoT device 620 to properly decode forward link waveforms containing CPs; thus, the wireless communication device 610 may multiplex transmissions with the forward link waveform and thereby conserve transmission resources.

The indication of the duration of the CP may enable the ambient IoT device 620 to properly decode the forward link waveform. For example, the ambient IoT device 620 may accurately skip the CP samples (for example, the ambient IoT device 620 may skip samples during the CP). The duration of the CP may enable the ambient IoT device 620 to identify CP symbol boundaries (for example, at which symbols the CP starts and ends). As a result, the ambient IoT device 620 may, during envelope detection, accurately detect the transmitted symbols of the forward link waveform.

The indication that the CP is to be included in the forward link waveform comprising the SIB or the synchronization signal may enable low-complexity solutions and/or increase opportunities for FDM. For example, the indication that the CP is to be included in the forward link waveform comprising the SIB may enable the ambient IoT device 620 to perform a relatively low-complex search for the SIB (for example, rather than performing a relatively high-complexity search for different synchronization signals). Additionally or alternatively, the indication that the CP is to be included in the forward link waveform comprising the synchronization signal may enable the SIB to be transmitted with a CP, and, thus, the SIB may be multiplexed using FDM.

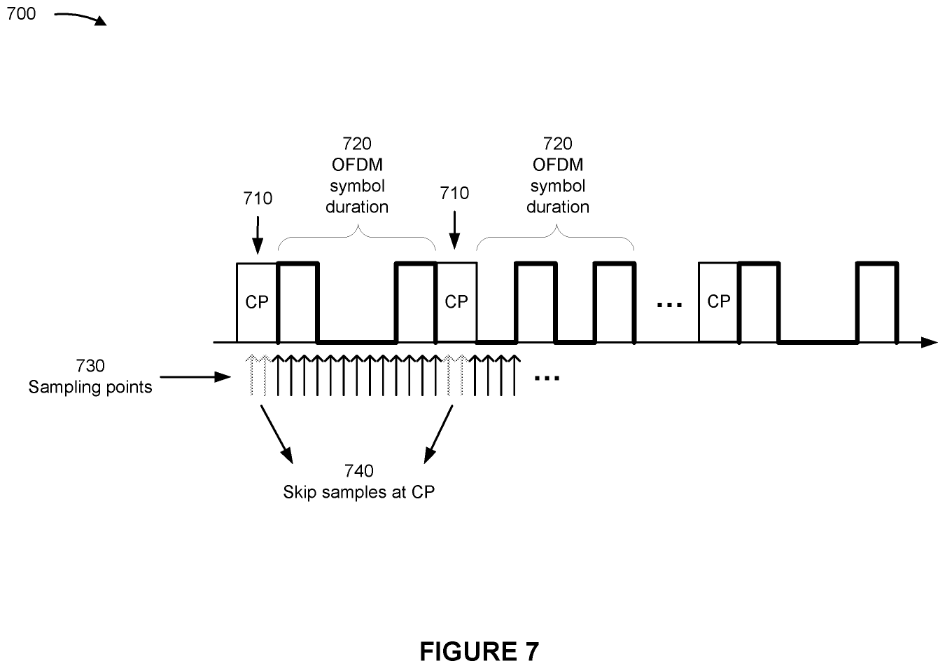

FIG. 7 is a diagram illustrating an example 700 associated with an OOK waveform transmitted with a CP.

Example 700 illustrates an OOK waveform that can be decoded by an ambient IoT device (for example, ambient IoT device 620) operating in a co-source deployment. As shown, the OOK waveform may include CPs 710 and data information in OFDM symbol durations 720. Because CPs 710 are present, the OFDM symbol durations 720 are non-consecutive (for example, the OFDM symbol durations 720 are interrupted by the CPs 710).

Upon receiving the OOK waveform (for example, the OOK waveform with a CP), the ambient IoT device may sample the OOK waveform at sampling points 730. Because the OFDM symbol durations 720 are non-consecutive, the ambient IoT device may sample the OOK waveform non-continuously. For example, at an operation 740, the ambient IoT device may skip sampling at the CPs 710. The ambient IoT device May skip the sampling based at least in part on an indication that a CP is to be included in the OOK waveform. Due to the presence of CPs 710 in the OOK waveform, the OOK waveform may be multiplexed with other data transmissions.

FIG. 8 is a flowchart illustrating an example process 800 performed, for example, at an ambient IoT device or an apparatus of an ambient IoT device that supports a CP for forward link waveforms. Example process 800 is an example where the apparatus or the ambient IoT device (for example, the ambient IoT device 620) performs operations associated with a CP for forward link waveform.

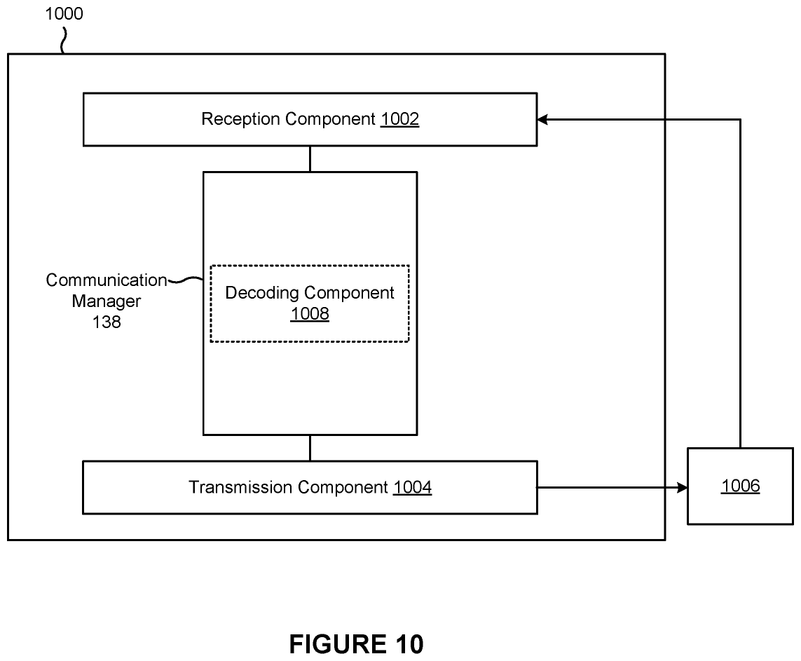

As shown in FIG. 8, in some aspects, process 800 may include receiving an indication that a CP is to be included in a forward link waveform (block 810). For example, the ambient IoT device (such as by using communication manager 138 or reception component 1002, depicted in FIG. 10) may receive an indication that a CP is to be included in a forward link waveform, as described above.

As further shown in FIG. 8, in some aspects, process 800 may include decoding the forward link waveform in accordance with the indication that the CP is to be included in the forward link waveform (block 820). For example, the ambient IoT device (such as by using communication manager 138 or decoding component 1008, depicted in FIG. 10) may decode the forward link waveform in accordance with the indication that the CP is to be included in the forward link waveform, as described above.

Process 800 may include additional aspects, such as any single aspect or any combination of aspects described below or in connection with one or more other processes described elsewhere herein.

In a first additional aspect, the forward link waveform is an OOK waveform.

In a second additional aspect, alone or in combination with the first aspect, process 800 includes receiving an indication of a duration of the CP, and one or more of the duration of the CP or a symbol duration of the forward link waveform is an integer multiple of a sampling rate of the ambient IoT device.

In a third additional aspect, alone or in combination with one or more of the first and second aspects, the indication that the CP is to be included in the forward link waveform comprises at least one of a SIB or a synchronization signal.

In a fourth additional aspect, alone or in combination with one or more of the first through third aspects, the indication that the CP is to be included in the forward link waveform comprises the SIB, and process 800 includes receiving the forward link waveform including the CP.

In a fifth additional aspect, alone or in combination with one or more of the first through fourth aspects, the indication that the CP is to be included in the forward link waveform comprises the synchronization signal transmitted without any CP and in a duration associated with non-FDM data transmissions.

In a sixth additional aspect, alone or in combination with one or more of the first through fifth aspects, process 800 includes decoding the SIB or the synchronization signal, and decoding the forward link waveform includes skipping detection of the CP.

In a seventh additional aspect, alone or in combination with one or more of the first through sixth aspects, the indication that the CP is to be included in the forward link waveform comprises a control signal associated with the forward link waveform.

Although FIG. 8 shows example blocks of process 800, in some aspects, process 800 may include additional blocks, fewer blocks, different blocks, or differently arranged blocks than those depicted in FIG. 8. Additionally or alternatively, two or more of the blocks of process 800 may be performed in parallel.

FIG. 9 is a flowchart illustrating an example process 900 performed, for example, at a wireless communication device or an apparatus of a wireless communication device that supports a CP for forward link waveforms. Example process 900 is an example where the apparatus or the wireless communication device (for example, the wireless communication device 610) performs operations associated with a CP for forward link waveforms.

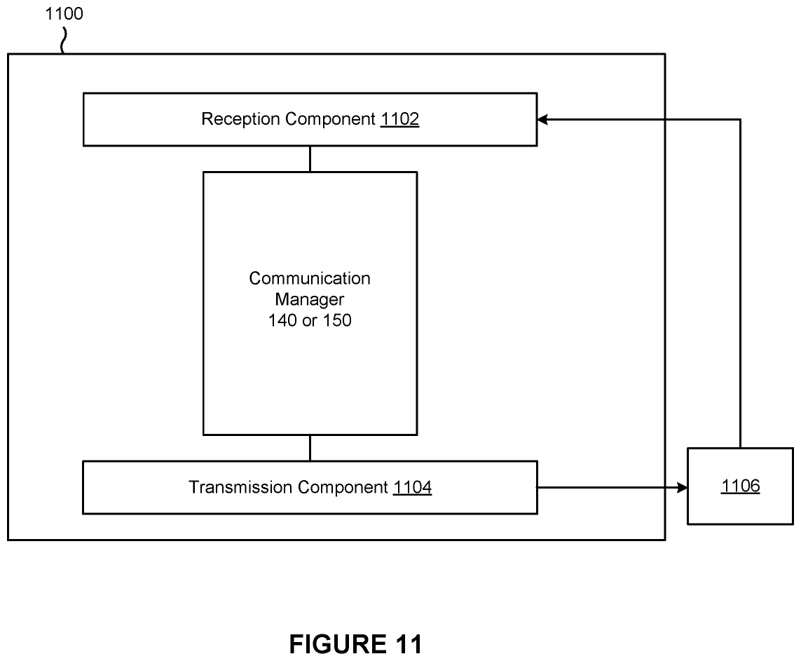

As shown in FIG. 9, in some aspects, process 900 may include transmitting an indication that a CP is to be included in a forward link waveform associated with an ambient IoT device (block 910). For example, the wireless communication device (such as by using communication manager 140 or 150 or transmission component 1104, depicted in FIG. 11) may transmit an indication that a CP is to be included in a forward link waveform associated with an ambient IoT device, as described above.

As further shown in FIG. 9, in some aspects, process 900 may include transmitting the forward link waveform in accordance with the indication that the CP is to be included in the forward link waveform (block 920). For example, the wireless communication device (such as by using communication manager 140 or 150 or transmission component 1004, depicted in FIG. 10) may transmit the forward link waveform in accordance with the indication that the CP is to be included in the forward link waveform, as described above.

Process 900 may include additional aspects, such as any single aspect or any combination of aspects described below or in connection with one or more other processes described elsewhere herein.

In a first additional aspect, the forward link waveform is an OOK waveform.

In a second additional aspect, alone or in combination with the first aspect, process 900 includes transmitting an indication of a duration of the CP, and one or more of the duration of the CP or a symbol duration of the forward link waveform is an integer multiple of a sampling rate of the ambient IoT device.

In a third additional aspect, alone or in combination with one or more of the first and second aspects, the indication that the CP is to be included in the forward link waveform comprises at least one of a SIB or a synchronization signal.

In a fourth additional aspect, alone or in combination with one or more of the first through third aspects, the indication that the CP is to be included in the forward link waveform comprises the SIB.

In a fifth additional aspect, alone or in combination with one or more of the first through fourth aspects, the indication that the CP is to be included in the forward link waveform comprises the synchronization signal transmitted without another CP and in a duration associated with non-FDM data transmissions.

In a sixth additional aspect, alone or in combination with one or more of the first through fifth aspects, the indication that the CP is to be included in the forward link waveform comprises a control signal associated with the forward link waveform.

In a seventh additional aspect, alone or in combination with one or more of the first through sixth aspects, the wireless communication device is a UE or a network node.

Although FIG. 9 shows example blocks of process 900, in some aspects, process 900 may include additional blocks, fewer blocks, different blocks, or differently arranged blocks than those depicted in FIG. 9. Additionally or alternatively, two or more of the blocks of process 900 may be performed in parallel.

FIG. 10 is a diagram of an example apparatus 1000 for wireless communication that supports CPs for forward link waveforms. The apparatus 1000 may be a ambient IoT device, or a ambient IoT device may include the apparatus 1000. In some aspects, the apparatus 1000 includes a reception component 1002, a transmission component 1004, and a communication manager 138, which may be in communication with one another (for example, via one or more buses). As shown, the apparatus 1000 may communicate with another apparatus 1006 (such as a UE, a network node, or another wireless communication device) using the reception component 1002 and the transmission component 1004.

In some aspects, the apparatus 1000 may be configured to and/or operable to perform one or more operations described herein in connection with FIGS. 6 and 7. Additionally or alternatively, the apparatus 1000 may be configured to and/or operable to perform one or more processes described herein, such as process 800 of FIG. 8. In some aspects, the apparatus 1000 may include one or more components of the ambient IoT device described above in connection with FIG. 2.

The reception component 1002 may receive communications, such as reference signals, control information, and/or data communications, from the apparatus 1006. The reception component 1002 may provide received communications to one or more other components of the apparatus 1000, such as the communication manager 138. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1002 may include one or more antennas, one or more modems, one or more demodulators, one or more MIMO detectors, one or more receive processors, one or more controllers/processors, and/or one or more memories of the ambient IoT device described above in connection with FIG. 2.

The transmission component 1004 may transmit communications, such as reference signals, control information, and/or data communications, to the apparatus 1006. In some aspects, the communication manager 138 may generate communications and may transmit the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, one or more modems, one or more modulators, one or more transmit MIMO processors, one or more transmit processors, one or more controllers/processors, and/or one or more memories of the ambient IoT device described above in connection with FIG. 2. In some aspects, the transmission component 1004 may be co-located with the reception component 1002 in one or more transceivers.

The communication manager 138 may receive or may cause the reception component 1002 to receive an indication that a CP is to be included in a forward link waveform. The communication manager 138 may decode the forward link waveform in accordance with the indication that the CP is to be included in the forward link waveform. In some aspects, the communication manager 138 may perform one or more operations described elsewhere herein as being performed by one or more components of the communication manager 138.

The communication manager 138 may include one or more controllers/processors and/or one or more memories of the ambient IoT device described above in connection with FIG. 2. In some aspects, the communication manager 138 includes a set of components, such as a decoding component 1008. Alternatively, the set of components may be separate and distinct from the communication manager 138. In some aspects, one or more components of the set of components may include or may be implemented within one or more controllers/processors and/or one or more memories, of the ambient IoT device described above in connection with FIG. 2. Additionally or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive an indication that a CP is to be included in a forward link waveform. The decoding component 1008 may decode the forward link waveform in accordance with the indication that the CP is to be included in the forward link waveform. In some examples, the reception component 1002 may receive an indication of a duration of the CP. In some examples, the decoding component 1008 may decode the SIB or the synchronization signal.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally or alternatively, a set of (one or more) components shown in FIG. 10 may perform one or more functions described as being performed by another set of components shown in FIG. 10.

FIG. 11 is a diagram of an example apparatus 1100 for wireless communication that supports CPs for forward link waveforms. The apparatus 1100 may be a wireless communication device, or a wireless communication device may include the apparatus 1100. In some aspects, the apparatus 1100 includes a reception component 1102, a transmission component 1104, and a communication manager 140 or 150, which may be in communication with one another (for example, via one or more buses). As shown, the apparatus 1100 may communicate with another apparatus 1106 (such as a UE, a network node, or another wireless communication device) using the reception component 1102 and the transmission component 1104.

In some aspects, the apparatus 1100 may be configured to and/or operable to perform one or more operations described herein in connection with FIG. 6 or 7. Additionally or alternatively, the apparatus 1100 may be configured to and/or operable to perform one or more processes described herein, such as process 900 of FIG. 9. In some aspects, the apparatus 1100 may include one or more components of the wireless communication device described above in connection with FIG. 2.

The reception component 1102 may receive communications, such as reference signals, control information, and/or data communications, from the apparatus 1106. The reception component 1102 may provide received communications to one or more other components of the apparatus 1100, such as the communication manager 140 or 150. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1102 may include one or more antennas, one or more modems, one or more demodulators, one or more MIMO detectors, one or more receive processors, one or more controllers/processors, and/or one or more memories of the wireless communication device described above in connection with FIG. 2.

The transmission component 1104 may transmit communications, such as reference signals, control information, and/or data communications, to the apparatus 1106. In some aspects, the communication manager 140 or 150 may generate communications and may transmit the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, one or more modems, one or more modulators, one or more transmit MIMO processors, one or more transmit processors, one or more controllers/processors, and/or one or more memories of the wireless communication device described above in connection with FIG. 2. In some aspects, the transmission component 1104 may be co-located with the reception component 1102 in one or more transceivers.

The communication manager 140 or 150 may transmit or may cause the transmission component 1104 to transmit an indication that a CP is to be included in a forward link waveform associated with an ambient IoT device. The communication manager 140 or 150 may transmit or may cause the transmission component 1104 to transmit the forward link waveform in accordance with the indication that the CP is to be included in the forward link waveform. In some aspects, the communication manager 140 or 150 may perform one or more operations described elsewhere herein as being performed by one or more components of the communication manager 140 or 150. The communication manager 140 or 150 may include one or more controllers/processors, one or more memories, one or more schedulers, and/or one or more communication units of the wireless communication device described above in connection with FIG. 2.

In some examples, the transmission component 1104 may transmit an indication that a CP is to be included in a forward link waveform associated with an ambient IoT device. In some examples, the transmission component 1104 may transmit the forward link waveform in accordance with the indication that the CP is to be included in the forward link waveform. In some examples, the transmission component 1104 may transmit an indication of a duration of the CP, wherein one or more of the duration of the CP or a symbol duration of the forward link waveform is an integer multiple of a sampling rate of the ambient IoT device.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by an ambient IoT device, comprising: receiving an indication that a CP is to be included in a forward link waveform; and decoding the forward link waveform in accordance with the indication that the CP is to be included in the forward link waveform.

Aspect 2: The method of Aspect 1, wherein the forward link waveform is an OOK waveform.

Aspect 3: The method of any of Aspects 1-2, further comprising: receiving an indication of a duration of the CP, wherein one or more of the duration of the CP or a symbol duration of the forward link waveform is an integer multiple of a sampling rate of the ambient IoT device.

Aspect 4: The method of any of Aspects 1-3, wherein the indication that the CP is to be included in the forward link waveform comprises at least one of a SIB or a synchronization signal.

Aspect 5: The method of Aspect 4, wherein the indication that the CP is to be included in the forward link waveform comprises the SIB, the method further comprising: receiving the forward link waveform including the CP.

Aspect 6: The method of Aspect 4, wherein the indication that the CP is to be included in the forward link waveform comprises the synchronization signal transmitted without any CP and in a duration associated with non-FDM data transmissions.

Aspect 7: The method of Aspect 4, further comprising: decoding the SIB or the synchronization signal, wherein decoding the forward link waveform includes skipping detection of the CP.

Aspect 8: The method of any of Aspects 1-7, wherein the indication that the CP is to be included in the forward link waveform comprises a control signal associated with the forward link waveform.

Aspect 9: A method of wireless communication performed by a wireless communication device, comprising: transmitting an indication that a CP is to be included in a forward link waveform associated with an ambient IoT device; and transmitting the forward link waveform in accordance with the indication that the CP is to be included in the forward link waveform.

Aspect 10: The method of Aspect 9, wherein the forward link waveform is an OOK waveform.

Aspect 11: The method of any of Aspects 9-10, further comprising: transmitting an indication of a duration of the CP, wherein one or more of the duration of the CP or a symbol duration of the forward link waveform is an integer multiple of a sampling rate of the ambient IoT device.

Aspect 12: The method of any of Aspects 9-11, wherein the indication that the CP is to be included in the forward link waveform comprises at least one of a SIB or a synchronization signal.

Aspect 13: The method of Aspect 12, wherein the indication that the CP is to be included in the forward link waveform comprises the SIB.

Aspect 14: The method of Aspect 12, wherein the indication that the CP is to be included in the forward link waveform comprises the synchronization signal transmitted without another CP and in a duration associated with non-FDM data transmissions.

Aspect 15: The method of any of Aspects 9-14, wherein the indication that the CP is to be included in the forward link waveform comprises a control signal associated with the forward link waveform.

Aspect 16: The method of any of Aspects 9-15, wherein the wireless communication device is a UE or a network node.

Aspect 17: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-16.

Aspect 18: An apparatus for wireless communication at a device, the apparatus comprising one or more memories and one or more processors coupled to the one or more memories, the one or more processors configured to cause the device to perform the method of one or more of Aspects 1-16.

Aspect 19: An apparatus for wireless communication, the apparatus comprising at least one means for performing the method of one or more of Aspects 1-16.

Aspect 20: A non-transitory computer-readable medium storing code for wireless communication, the code comprising instructions executable by one or more processors to perform the method of one or more of Aspects 1-16.

Aspect 21: A non-transitory computer-readable medium storing a set of instructions for wireless communication, the set of instructions comprising one or more instructions that, when executed by one or more processors of a device, cause the device to perform the method of one or more of Aspects 1-16.

Aspect 22: A device for wireless communication, the device comprising a processing system that includes one or more processors and one or more memories coupled with the one or more processors, the processing system configured to cause the device to perform the method of one or more of Aspects 1-16.

Aspect 23: An apparatus for wireless communication at a device, the apparatus comprising one or more memories and one or more processors coupled to the one or more memories, the one or more processors individually or collectively configured to cause the device to perform the method of one or more of Aspects 1-16.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, the term “determine” or “determining” encompasses a wide variety of actions and, therefore, “determining” can include calculating, computing, processing, deriving, investigating, looking up (such as via looking up in a table, a database or another data structure), identifying, inferring, ascertaining, measuring, and the like. Also, “determining” can include receiving (such as receiving information or receiving an indication), accessing (such as accessing data stored in memory), transmitting (such as transmitting information) and the like. Also, “determining” can include resolving, selecting, obtaining, choosing, establishing and other such similar actions. The term “identify” or “identifying” also encompasses a wide variety of actions and, therefore, “identifying” can include calculating, computing, processing, deriving, investigating, looking up (such as via looking up in a table, a database or another data structure), inferring, ascertaining, measuring, and the like. Also, “identifying” can include receiving (such as receiving information or receiving an indication), accessing (such as accessing data stored in memory), transmitting (such as transmitting information) and the like. Also, “identifying” can include resolving, selecting, obtaining, choosing, establishing and other such similar actions.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, as used herein, “based on” is intended to be interpreted in the inclusive sense, unless otherwise explicitly indicated. For example, “based on” may be used interchangeably with “based at least in part on,” “associated with”, or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions or information. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. An apparatus for wireless communication at an ambient internet of things (IoT) device, comprising:
one or more memories storing processor-executable code; and
one or more processors coupled with the one or more memories, at least one processor of the one or more processors configured to cause the ambient IoT device to:
receive an indication that a cyclic prefix (CP) is to be included in a forward link waveform; and
decode the forward link waveform in accordance with the indication that the CP is to be included in the forward link waveform.

2. The apparatus of claim 1, wherein the forward link waveform is an on-off keying (OOK) waveform.

3. The apparatus of claim 1, wherein at least one processor of the one or more processors is further configured to cause the ambient IoT device to:
receive an indication of a duration of the CP, wherein one or more of the duration of the CP or a symbol duration of the forward link waveform is an integer multiple of a sampling rate of the ambient IoT device.

4. The apparatus of claim 1, wherein the indication that the CP is to be included in the forward link waveform comprises at least one of a system information block (SIB) or a synchronization signal.

5. The apparatus of claim 4, wherein the indication that the CP is to be included in the forward link waveform comprises the SIB, and wherein at least one processor of the one or more processors is further configured to cause the ambient IoT device to:
receive the forward link waveform including the CP.

6. The apparatus of claim 4, wherein the indication that the CP is to be included in the forward link waveform comprises the synchronization signal transmitted without any CP and in a duration associated with non-frequency-division-multiplexing data transmissions.

7. The apparatus of claim 4, wherein at least one processor of the one or more processors is further configured to cause the ambient IoT device to:
decode the SIB or the synchronization signal, wherein the at least one processor, configured to cause the ambient IoT device to decode the forward link waveform, is configured to cause the ambient IoT device to skip detection of the CP.

8. The apparatus of claim 1, wherein the indication that the CP is to be included in the forward link waveform comprises a control signal associated with the forward link waveform.

9. An apparatus for wireless communication at a wireless communication device, comprising:
one or more memories storing processor-executable code; and
one or more processors coupled with the one or more memories, at least one processor of the one or more processors configured to cause the wireless communication device to:
transmit an indication that a cyclic prefix (CP) is to be included in a forward link waveform associated with an ambient internet of things (IoT) device; and
transmit the forward link waveform in accordance with the indication that the CP is to be included in the forward link waveform.

10. The apparatus of claim 9, wherein the forward link waveform is an on-off keying (OOK) waveform.

11. The apparatus of claim 9, wherein at least one processor of the one or more processors is further configured to cause the wireless communication device to:
transmit an indication of a duration of the CP, wherein one or more of the duration of the CP or a symbol duration of the forward link waveform is an integer multiple of a sampling rate of the ambient IoT device.

12. The apparatus of claim 9, wherein the indication that the CP is to be included in the forward link waveform comprises at least one of a system information block (SIB) or a synchronization signal.

13. The apparatus of claim 12, wherein the indication that the CP is to be included in the forward link waveform comprises the SIB.

14. The apparatus of claim 12, wherein the indication that the CP is to be included in the forward link waveform comprises the synchronization signal transmitted without another CP and in a duration associated with non-frequency-division-multiplexing data transmissions.

15. The apparatus of claim 9, wherein the indication that the CP is to be included in the forward link waveform comprises a control signal associated with the forward link waveform.

16. The apparatus of claim 9, wherein the wireless communication device is a user equipment (UE) or a network node.

17. A method of wireless communication performed at an ambient internet of things (IoT) device, comprising:
receiving an indication that a cyclic prefix (CP) is to be included in a forward link waveform; and
decoding the forward link waveform in accordance with the indication that the CP is to be included in the forward link waveform.

18. The method of claim 17, wherein the forward link waveform is an on-off keying (OOK) waveform.

19. The method of claim 17, further comprising:
receiving an indication of a duration of the CP, wherein one or more of the duration of the CP or a symbol duration of the forward link waveform is an integer multiple of a sampling rate of the ambient IoT device.

20. The method of claim 17, wherein the indication that the CP is to be included in the forward link waveform comprises at least one of a system information block (SIB) or a synchronization signal.
